(19) United States
(12) Patent Application Publication
(10) Pub. No.: US 2020/0341977 A1
(43) Pub. Date: Oct. 29, 2020

(54) METHOD AND APPARATUS FOR MANAGING ATTRIBUTE LANGUAGE

(71) Applicant: MYCELEBS CO., LTD., Seoul (KR)

(72) Inventor: Jun Woong DOH, Seoul (KR)

(21) Appl. No.: 16/859,392

(22) Filed: Apr. 27, 2020

(30) Foreign Application Priority Data
Apr. 25, 2019 (KR) 10-2019-0048369
Aug. 5, 2019 (KR) 10-2019-0094688

(51) Int. Cl. G06F 16/2453; G06F 3/0482; G06F 40/237

(52) U.S. Cl. CPC G06F 16/2453; G06F 40/237; G06F 3/0482

(57) ABSTRACT

A method of managing attribute language by an information providing apparatus includes: when an upper attribute keyword is selected, based on a first upper attribute-middle attribute correlation corresponding to pairs of upper attribute keywords-middle attribute keywords, generating a middle attribute set including middle attribute keywords having the first upper attribute-middle attribute correlation higher than or equal to a reference value; providing an interface for adding or deleting a middle attribute keyword to or from the middle attribute set, along with the upper attribute keyword, and adding or deleting, according to a user's input, a middle attribute keyword to or from the middle attribute set; calculating a first upper attribute keyword-object correlation corresponding to a pair of the selected upper attribute keyword and an object selected based on a first middle attribute keyword-object correlation; and providing the object corresponding to the first upper attribute keyword-object correlation to the interface.

### CROSS-REFERENCE TO RELATED APPLICATION

This application claims priority under 35 U.S.C. § 119 to Korean Patent Application No. 10-2019-0048369, filed on Apr. 25, 2019, in the Korean Intellectual Property Office (KIPO), the disclosure of which is incorporated by reference herein in its entirety.

### TECHNICAL FIELD

Embodiments of the present disclosure relate to a method and an apparatus for managing attribute languages.

### DISCUSSION OF RELATED ART

According to conventional search methods, a user may search for a desired web document or the like by entering a search keyword into a search box. For example, a user may retrieve information about the movie ‘Interstellar’ by entering the title of the movie ‘Interstellar’ into the search box. However, if a user cannot remember the title of a movie which he or she desires to search for, he or she needs to provide another type of information. For example, a user may attempt a search by entering an actor, director, producer, or the like of a movie which he or she desires to search for. There are many cases where movie information sites and movie review sites provide cast information as well as movie information, and thus the user may search for a desired movie by using an actor, a director, a producer, or the like as a keyword unless he or she is unlucky.

Meanwhile, the conventional search methods cannot be used if information to be used is information based on an atypical language, for example, an emotional language, rather than typical information. For example, responses provided by conventional search engines for a search term, such as ‘a funny movie’ or ‘a movie which is viewed when a viewer is sad,’ are merely search results, including documents which have been written to include the keyword ‘a funny movie’ or ‘a movie viewed when a viewer is sad.’ However, an atypical language requires an approach different from that for typical information, such as a starring actor, a (typical) movie genre, and a year of release. Even if documents have not been written to include the keyword ‘a funny movie’ or ‘a movie viewed when a viewer is sad,’ there could be a lot of movies for which many people might feel is ‘fun’ or ‘sad.’ Furthermore, for other fields than film, a different approach may be required for requesting information by using an atypical language.

### DETAILED DESCRIPTION OF THE INVENTION

### Technical Objectives

Embodiments of the present disclosure may be directed to a method and an apparatus for managing attribute languages.

### Technical Solution to the Problem

According to an embodiment, a method of managing attribute language by an information providing apparatus includes: when an upper attribute keyword is selected, based on a first upper attribute-middle attribute correlation corresponding to pairs of upper attribute keywords-middle attribute keywords, generating a middle attribute set including middle attribute keywords having the first upper attribute-middle attribute correlation higher than or equal to a reference value; providing an interface for adding or deleting a middle attribute keyword to or from the middle attribute set, along with the upper attribute keyword, and adding or deleting, according to a user's input, a middle attribute keyword to or from the middle attribute set; calculating a first upper attribute keyword-object correlation corresponding to a pair of the selected upper attribute keyword and an object selected based on a first middle attribute keyword-object correlation; and providing the object corresponding to the first upper attribute keyword-object correlation to the interface.

In some embodiments, the method may further include providing an interface including an attribute set, and receiving an input of a second upper attribute-middle attribute correlation for each middle attribute keyword selected through the interface; and correcting the first upper attribute-middle attribute correlation by reflecting the second upper attribute-middle attribute correlation.

In some embodiments, the method may further include indicating the middle attribute keywords of the middle attribute set to be distinguished from other middle attribute keywords; and indicating middle attribute keywords other than the middle attribute set to be distinguished from one another according to a range to which average similarities with the middle attribute keywords of the middle attribute set belong.

In some embodiments, receiving the input of the second upper attribute-middle attribute correlation may include receiving an input of a change in arrangement order of the middle attribute keywords included in the middle attribute set through the interface; and changing the second upper attribute-middle attribute correlation with a predetermined correlation corresponding to the arrangement order.

In some embodiments, the method may further include: before generating the middle attribute set, generating an upper attribute filter including a plurality of preset upper attribute keywords; and providing an interface including the upper attribute filter and receiving a selection of an arbitrary upper attribute keyword through the interface.

In some embodiments, the method may further include: before generating the upper attribute filter, providing an interface including a plurality of preset items of interest, and receiving a selection of an arbitrary item of interest through the interface; and resetting, as the upper attribute keyword, the upper attribute keyword correlated with the item of interest.

In some embodiments, the method may further include: before generating the middle attribute set, storing the first middle attribute keyword-object correlation based on a first middle attribute-lower attribute correlation corresponding to pairs of middle attribute keywords and lower attribute keywords and a first lower attribute-object correlation corresponding to pairs of lower attribute keywords and objects.

In some embodiments, calculating the first upper attribute keyword-object correlation corresponding to the pairs of the upper attribute keywords and the objects may include calculating the first upper attribute keyword-object correlation corresponding to the pairs of the upper attribute keywords and the objects by multiplying the first upper attribute-middle attribute correlation by the first middle attribute keyword-object correlation.

According to another embodiment, an information providing apparatus includes: a storage configured to store a first upper attribute-middle attribute correlation corresponding to pairs of upper attribute keywords and middle attribute keywords and a first middle attribute keyword-object correlation corresponding to pairs of middle attribute keywords and objects; a controller configured to generate a middle attribute set including middle attribute keywords having the first upper attribute-middle attribute correlation higher than or equal to a reference value and to provide an interface for adding or deleting a middle attribute keyword to or from the middle attribute set, along with the upper attribute keyword; and a communication unit configured to receive addition/delete of the middle attribute keyword to or from the middle attribute set by a user's input through the interface.

In some embodiments, the controller may calculate a first upper attribute keyword-object correlation corresponding to a pair of the selected upper attribute keyword and an object selected based on a first middle attribute keyword-object correlation and provide the object corresponding to the first upper attribute keyword-object correlation to the interface.

In some embodiments, the controller may provide an interface including an attribute set, receives an input of a second upper attribute-middle attribute correlation for each middle attribute keyword selected through the interface and correct the first upper attribute-middle attribute correlation by reflecting the second upper attribute-middle attribute correlation.

In some embodiments, the interface may indicate the middle attribute keywords of the middle attribute set to be distinguished from other middle attribute keywords, and indicate middle attribute keywords other than the middle attribute set to be distinguished from one another according to a range to which average similarities with the middle attribute keywords of the middle attribute set belong.

In some embodiments, the communication unit may receive an input of a change in arrangement order of the middle attribute keywords included in the middle attribute set through the interface, and the controller may change the second upper attribute-middle attribute correlation with a predetermined correlation corresponding to the arrangement order.

In some embodiments, the controller may generate an upper attribute filter including a plurality of preset upper attribute keywords and provides an interface including the upper attribute filter, and the communication unit may receive an input of an arbitrary upper attribute keyword through the interface.

In some embodiments, the controller may provide an interface including a plurality of preset items of interest, and reset, as the upper attribute keyword, the upper attribute keyword correlated with the item of interest input through the interface.

In some embodiments, the controller may calculate the first middle attribute keyword-object correlation based on a first middle attribute-lower attribute correlation corresponding to pairs of middle attribute keywords and lower attribute keywords and a first lower attribute-object correlation corresponding to pairs of lower attribute keywords and objects.

In some embodiments, the controller may calculate the first upper attribute keyword-object correlation corresponding to the pairs of the upper attribute keywords and the objects by multiplying the first upper attribute-middle attribute correlation by the first middle attribute keyword-object correlation.

### BRIEF DESCRIPTION OF THE DRAWINGS

FIG. 1 is a network configuration diagram illustrating an information providing system using an attribute language according to an embodiment of the present disclosure.

FIG. 2 is a block diagram illustrating a terminal according to an embodiment of the present disclosure.

FIG. 3 is a block diagram illustrating an information providing apparatus according to an embodiment of the present disclosure.

FIG. 4 is a flowchart illustrating an information providing process through an information providing interface according to an embodiment of the present disclosure.

FIG. 5 is a detailed flowchart illustrating operation 910 according to an embodiment of the present disclosure.

FIG. 6 is a detailed flowchart illustrating operation 510 according to an embodiment of the present disclosure.

FIG. 7 is a detailed flowchart illustrating operation 530 according to an embodiment of the present disclosure.

FIG. 8 is a detailed flowchart illustrating operation 910 according to another embodiment of the present disclosure.

FIG. 9 is a flowchart illustrating a method of managing attribute language according to an embodiment of the present disclosure.

FIG. 10 illustrates an example of a stored object-keyword correlation according to an embodiment of the present disclosure.

FIG. 11 is a detailed flowchart illustrating operation 940 according to an embodiment of the present disclosure.

FIG. 12 illustrates an example of an interface page including an attribute filter according to another embodiment of the present disclosure.

FIG. 13 illustrates an example of a portion of an interface page including an attribute filter according to an embodiment of the present disclosure.

FIGS. 14 and 15 illustrate examples of interface pages including a second attribute filter according to an embodiment of the present disclosure.

FIG. 16 illustrates an example of an interface page including a result previewer according to an embodiment of the present disclosure.

FIG. 17 illustrates an example of an interface page including an attribute filter according to another embodiment of the present disclosure.

FIG. 18 illustrates an example of an interface page including a weight adjuster according to an embodiment of the present disclosure.

### DETAILED DESCRIPTION

Embodiments of the present disclosure will be described in detail below with reference to the accompanying drawings.

In descriptions of the embodiments, descriptions of techniques which are well known in the art to which this disclosure belongs and which are not directly related to this disclosure will be omitted. This is to more clearly convey the gist of the present disclosure without making the gist of the present disclosure obscure by omitting unnecessary descriptions.

For the same reason, in the accompanying drawings, some components are exaggerated, omitted, or schematically illustrated. Also, the size of each component does not completely reflect the actual size thereof. Throughout the drawings, the same or corresponding components are denoted by the same reference symbols.

Hereinafter, embodiments of the present disclosure will be described in detail with reference to the accompanying drawings.

According to some embodiments of the present disclosure, a reserved word may refer to a character string that may be expressed or defined through correlation information with other keywords, or of which characteristics, utilization modes, properties and the like may be expressed and defined therethrough. However, reserved words that are defined/expressed in another manner, for example, by a manual input of a manager, may also be applied to the present disclosure. The detailed configuration of the correlation information will be described below. The reserved word may also be referred to as Keytalk™ in the sense that it becomes a key of talk.

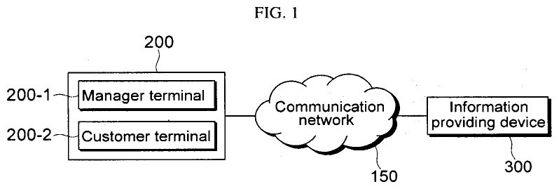

FIG. 1 is a network configuration diagram illustrating an information providing system using an attribute language according to an embodiment of the present disclosure.

Referring to FIG. 1, the information providing system according to an embodiment may include a terminal 200, an information providing apparatus 300, and a communication network 150.

The terminal 200 may be implemented as, e.g., a smartphone, a PDA, a tablet PC, a notebook computer, a laptop computer, a personal computer, another electronic apparatus capable of performing communication, receiving input from a user, and outputting screens, or a similar apparatus.

The terminal 200 may be a manager terminal 200-1 or a customer terminal 200-2.

The manager terminal 200-1 is, for example, a terminal used by a manager who provides an information service.

The customer terminal 200-2 is a terminal used by a customer who receives thes information service.

The information providing apparatus 300 may be implemented as, for example, a workstation, a server, a general-purpose computer, or other electronic apparatuses capable of performing communication or similar apparatuses.

As illustrated in FIG. 1, the terminal 200 and the information providing apparatus 300 are connected to each other through the communication network 150 and may communicate with each other through the communication network 150. In addition, the manager terminal 200-1 may access the information providing apparatus 300 through an interface directly provided by the information providing apparatus 300.

When the manager terminal 200-1 accesses the information providing apparatus 300 through an interface directly provided by the information providing apparatus 300, the information providing apparatus 300 includes a configuration of a web server or an application server. In such a case, the configuration of the web server/application server included in the information providing apparatus 300 may be referred to as an interface module. The interface module may serve as a web server/application server, which will be described below. The web server/application server may input information or transmit a request message through an interface to the accessed terminal and may receive information and/or a request message delivered by the connected terminal.

The communication network 150 may be implemented using at least part of Long Term Evolution (LTE), LTE-Advanced (LTE-A), WI-FI, Local Area Network (LAN), Wide Area Network (WAN), Code Division Multiple Access (CDMA), Time Division Multiple Access (TDMA), Wireless Broadband (WiBro), and Global System for Mobile Communications (GSM), and other communication methods developed in the past, being currently developed, and to be developed in the future. In the following, for the sake of convenience, the terminal 200 and the information providing apparatus 300 will be described as directly communicating with each other without mentioning the communication network 150.

In a case where the information providing apparatus 300 provides an interface for both the manager terminal 200-1 and the customer terminal 200-2, the information providing apparatus 300 may provide an interface for object recommendation and attribute language management when accessed by a pre-registered user (manager), and may provide an interface for limited information such as object retrieval and searching when accessed by other users (customer).

The information providing apparatus 300 may perform a user authentication or terminal authentication procedure to provide such a differentiated interface. For example, the information providing apparatus 300 distinguishes whether the connected terminal is a manager terminal or a customer terminal through a user authentication process for the connected terminal. Alternatively, the information providing apparatus 300 may register a connected terminal as a manager terminal through terminal authentication. The user authentication or terminal authentication procedure between the information providing apparatus 300 and the terminal 200 is technique already known, and thus detailed description will be omitted.

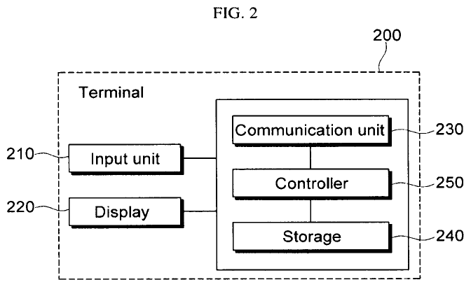

The detailed operations and configurations of the terminal 200 and the information providing apparatus 300 will be described below with reference to FIGS. 2 to 8.

FIG. 2 is a block diagram illustrating a terminal 200 according to an embodiment of the present disclosure.

Referring to FIG. 2, the terminal 200 according to an embodiment may include an input unit 210, a display 220, a communication unit 230, a storage 240, and a controller 250.

The input unit 210 converts an input operation of a user into an input signal, and transmits the input signal to the controller 250. The input unit 210 may be implemented as, e.g., a keyboard, a mouse, a touch sensor on a touch screen, a touchpad, a keypad, a voice input apparatus, or another input processing apparatus developed in the past, being currently developed, or to be developed in the future. For example, the input unit 210 may receive information providing request input from a user, and may transfer the information providing request input to the controller 250.

The display 220 outputs a screen under the control of the controller 250. The display 220 may be implemented as, e.g., a liquid crystal display (LCD) apparatus, a light-emitting diode (LED) apparatus, an organic LED (OLED) apparatus, a projector, or another display apparatus developed in the past, being currently developed, or to be developed in the future. For example, the display 220 may display an interface page or information providing result page for the providing of information. In some embodiment, a component using another method capable of transferring information to a user, such as voice output or vibration, rather than screen output, may be used in place of the display 220.

The communication unit 230 exchanges data with the information providing apparatus 300 and/or other external apparatuses. The communication unit 230 transfers data, received from the information providing apparatus 300, to the controller 250. Furthermore, the communication unit 230 transfers data to the information providing apparatus 300 under the control of the controller 250. The communication technology used by the communication unit 230 may vary depending on the type of communication network 150 or other circumstances.

The storage 240 stores data under the control of the controller 250, and transfers requested data to the controller 250.

The controller 250 controls the overall operation of the terminal 200 and individual components. In particular, the controller 250 transmits an information providing request or another type of data to the information providing apparatus 300 according to information input from the input unit 210, and displays a result page and/or an interface page via the display 220 according to page information received from the information providing apparatus 300, as will be described below.

The operation performed by the controller 250 may be distributed and processed by a plurality of arithmetic and logic units which are physically distributed. There is possible a method in which part of the operation performed by the controller 250 is performed by a first server and the remaining operation is performed by a second server. In such a case, the controller 250 may be implemented as the sum of the arithmetic and logic units which are physically distributed.

The storage 240 may be implemented as the sum of storage apparatuses which are physically separated from each other.

When the controller 250 or storage 240 is implemented as the sum of a plurality of apparatuses which are physically separated from each other, communication is required between the plurality of apparatuses. In such a case, for the sake of simplicity of description, the following description will be given on the assumption that the storage 240 or controller 250 is implemented as a single object.

In the case where the terminal 200 transmits or receives data, the communication unit 230 may be described as transmitting or receiving data under the control of the controller 250, or the controller 250 may be described as transmitting or receiving data by controlling the communication unit 230, depending on the point of view of a corresponding situation.

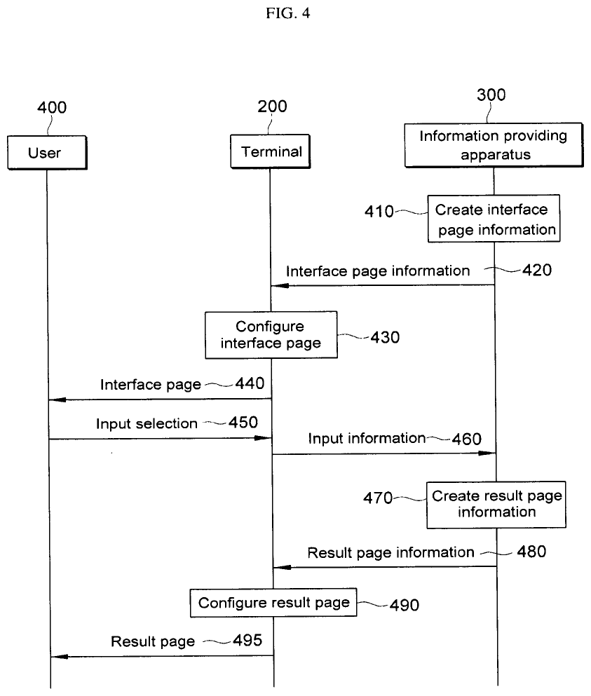

The detailed operations of the individual components of the terminal 200 will be described with reference to FIGS. 4 to 8.

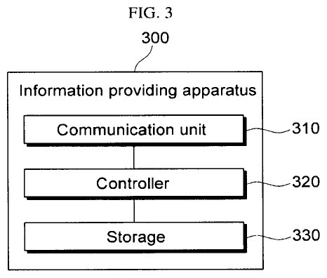

FIG. 3 is a block diagram illustrating an information providing apparatus 300 according to an embodiment of the present disclosure.

Referring to FIG. 3, the information providing apparatus 300 according to an embodiment may include a communication unit 310, a controller 320, and a storage 330.

The communication unit 310 exchanges data with the terminal 200 and/or other external apparatuses. The communication unit 310 transfers data, received from the terminal 200, to the controller 320. Furthermore, the communication unit 310 transfers data to the terminal 200 under the control of the controller 320. The communication technology used by the communication unit 310 may vary depending on the type of communication network 150 or other circumstances.

The storage 330 stores data under the control of the controller 320, and transfers data, requested by the controller 320, to the controller 320.

The controller 320 controls the overall operation of the information providing apparatus 300 and individual components. In particular, when the controller 320 receives an interface page request, an information providing result page request, or another type of data via the communication unit 310, the controller 320 retrieves required data from storage 330, generates load page information, and transfers page information to the terminal 200 via the communication unit 310, as will be described below.

In the case where the information providing apparatus 300 transmits or receives data, the communication unit 310 may be described as transmitting or receiving data under the control of the controller 320, or the controller 320 may be described as transmitting or receiving data by controlling the communication unit 310, depending on the point of view of a corresponding situation.

The detailed operations of the individual components of the information providing apparatus 300 will be described with reference to FIGS. 4 to 8.

According to another embodiment, data adapted to provide information by using a voice form or another method may be transmitted and received in place of a page adapted to visually provide information.

FIG. 4 is a flowchart illustrating a process of providing information via an information providing interface according to an embodiment of the present disclosure.

At 410, the controller 320 of the information providing apparatus 300 generates interface page information. The interface page is information required to generate an information interface page. The interface page is a page adapted to prompt the input of a user, to receive the input of the user, and to transfer the input of the user to the information providing apparatus 300. For example, the interface page information may be in the form of an HTML document or another markup language document. In another embodiment, the terminal 200 may have the form information of the interface page in advance, and only an item corresponding to content may be transferred from the information providing apparatus 300 to the terminal 200. In the following, for the sake of convenience, the following description will be given on the assumption that the interface page information or another type of page information is transferred in the form of an HTML document. However, the scope of the present disclosure is not limited thereto.

At 420, the communication unit 310 of the information providing apparatus 300 transfers the interface page information to the terminal 200.

At 430, the controller 250 of the terminal 200 constructs an interface page by using the interface page information. For example, the controller 250 may run a web browser, may interpret an HTML document, and may configure an interface page in the form of a web page. A separate application may be used in place of the web browser.

At 440, the display 220 of the terminal 200 displays the interface page to a user 400. The interface page may include an interface in which, e.g., the user 400 may request the providing of information, may input and/or select a keyword for the providing of the information, and may make other settings for the providing of the information.

At 450, the input unit 210 of the terminal 200 receives the selection input of the user 400 via the input interface page, and transfers the selection input to the controller 250.

At 460, the communication unit 230 of the terminal 200 transfers input information adapted to identify the selection input of the user 400 to the information providing apparatus 300 under the control of the controller 250.

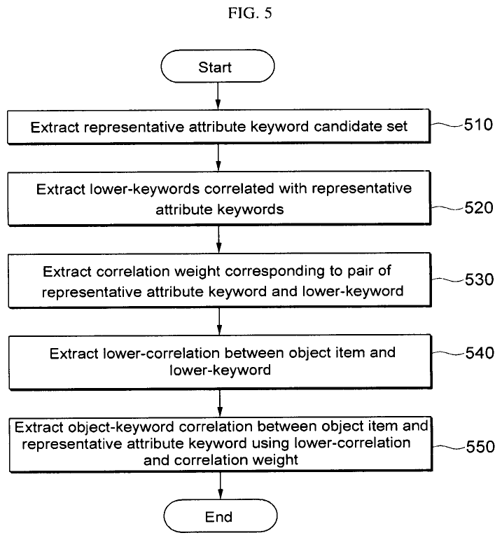

At 470, the controller 320 of the information providing apparatus 300 generates result page information by using the input (e.g., a keyword and/or another information providing setting) of the user 400. A preparation process of generating the result page information and a process of generating the result page information will be described with reference to FIGS. 5 to 11 below. The result page information may be configured, e.g., in the form of an HTML document and/or in the form of an image.

At 480, the communication unit 310 of the information providing apparatus 300 transfers the result page information to the terminal 200.

At 490, the controller 250 of the terminal 200 constructs a result page by using the result page information received by the communication unit 230. For example, the controller 250 may construct a result page by interpreting the result page information in an HTML form.

At 495, the display 220 of the terminal 200 provides the result page to the user 400.

Although it is assumed that a page in a visual form is provided to the user 400 in the embodiment of FIG. 4, the interface or result information may be provided by voice. In such a case, a voice output unit may be used in place of the display 220. Another type of interface method available currently or in the future may be used in conjunction with the user 400 in place of the visual/aural method. In such a case, the information providing apparatus 300 may provide information, obtained through conversion using another method, to the terminal 200 in place of the page information in accordance with the interface method.

In embodiments illustrated in the drawings starting from FIG. 5, the user 400 desires to receive information about an object in a specific field of interest in which he or she is interested in. However, the scope of the present disclosure is not limited thereto.

A field of interest may be, e.g., the type of objects. For example, when the field of interest is ‘great man,’ objects corresponding to this field of interest may include ‘King Sejong,’ ‘Lee Soon Shin,’ ‘Shinsaimdang’ etc. For example, when the field of interest is ‘movie,’ objects corresponding to this field of interest may include ‘Man in*,’ ‘Spider*,’ ‘Cinderell*,’ etc. For example, when the field of interest is ‘broadcast program,’ objects corresponding to this field of interest may include ‘Muhando*,’ ‘Rule of the Jun*,’ ‘Game of th*,’ etc.

In the following embodiments, documents are collected in order to evaluate the relationship (the degree of correlation, weight, and/or the like) between keywords. The collected documents may be evaluated as having the same value, or a newer document may be evaluated as having a higher value. In other words, the degrees of correlation between the age of a document based on an evaluation date and keywords appearing in the document may have a negative correlation.

In the process starting from FIG. 5, the value may vary depending on the up-to-dateness of a document. For example, the degree of correlation of a case where two keywords appear in a document which is one day old at evaluation time may be evaluated as being ten times higher than that of a case where two keywords appear in a document which is ten days old at the evaluation time. The age of a document may be evaluated, e.g., on a second/minute/hour basis or on a day/month/year basis. Although the control unit 320 is based on a document evaluated before the age of the document is reflected therein, the control unit 320 may extract the degree of correlation between two keywords by extracting the partial degree of correlation reflecting the age of the document through the division of the value of the partial degree of correlation by the age of the document and then accumulating the partial degrees of correlation.

The time at which a document was generated, which is used to determine the age of the document, may be determined using, e.g., a posting time included inside the document and/or metadata. Alternatively, when a document which had not been found during previous crawling is newly found through periodic crawling, it is determined that a new document is added at new crawling time.

FIG. 5 is a flowchart illustrating a method of storing object-keyword correlations as a pre-processing process for attribute language management according to an embodiment of the present disclosure.

Referring to FIG. 5, at 510, the controller 320 determines a representative attribute keyword candidate set from first set documents. For example, the controller 320 may collect, as the representative attribute keyword candidate set, keywords that frequently appear in the documents of the first set documents corresponding to a field of interest.

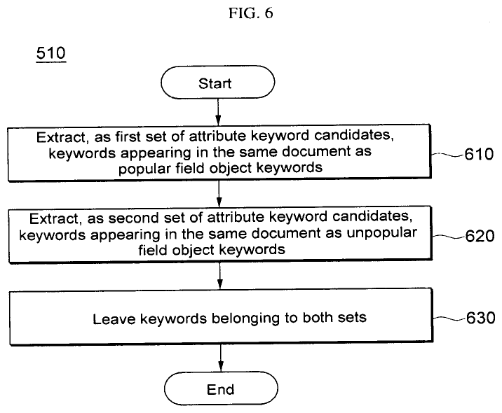

FIG. 6 is a detailed flowchart illustrating operation 510 according to an embodiment of the present disclosure.

The controller 320 may select keywords appearing in the same documents as object keywords representative of objects belonging to a specific field and keywords appearing in the same documents as field keywords representative of a specific field as a first attribute keyword candidate set and a second attribute keyword candidate set.

For example, when a target field of interest for the providing of information providing service is ‘celebrity,’ field keywords may include ‘celebrity,’ ‘entertainer,’ ‘movie star,’ ‘star,’ ‘celeb,’ etc. The field keywords may be set by a manager and may be recommended and set by the controller 320. The controller 320 may acquire some field keywords, and may then recommend and set similar keywords, whose degree of correlation with each of the field keywords is analyzed as being equal to or larger than a preset value, as additional field keywords.

When a target field of interest is ‘celebrity,’ object keywords may be individual persons belonging to the corresponding field of interest. That is, each person corresponding to a celebrity in the field of interest may be an object keyword.

As for the relationship between a field keyword and an object keyword, for example, a field keyword may correspond to the attribute or type of corresponding object keyword. A field keyword may be representative of a set, whereas an object keyword may be representative of an element belonging to a corresponding set.

Object keywords may be set by a manager, and may be selected using a method similar to the method of selecting field keywords. According to still another embodiment, the controller 320 may select keywords, determined to be elements of a set represented by a field keyword, as object keywords by analyzing the contexts of collected documents.

A popular object keyword and an unpopular object keyword may be distinguished from each other based on the quantities of the found/collected corresponding object keywords. The controller 320 may search for/collect documents containing each object keyword, and may set an object keyword, for which the quantity of collected documents is equal to or larger than a specific threshold value, as a popular object keyword and set an object keyword, for which the quantity of collected documents is smaller than a specific threshold value, as an unpopular object keyword.

A popular field keyword and an unpopular field keyword may be distinguished from each other based on the quantities of the found/collected corresponding field keywords. The controller 320 may search for/collect documents containing each field keyword, and may set a field keyword, for which the quantity of collected documents is equal to or larger than a specific threshold value, as a popular field keyword and set a field keyword, for which the quantity of collected documents is smaller than a specific threshold value, as an unpopular field keyword. However, the threshold value used to distinguish the popular object keyword and the unpopular object keyword from each other and the threshold value used to distinguish the popular field keyword and the unpopular field keyword from each other may be different values. In the following, for the sake of convenience, a popular object keyword and a popular field keyword may be collectively called a popular field/object keyword. Furthermore, for the sake of convenience, an unpopular object keyword and an unpopular field keyword may be collectively called an unpopular field/object keyword.

In a modified embodiment, only a popular field keyword or popular object keyword may be used in place of a popular field/object keyword. In a modified embodiment, only an unpopular field keyword or unpopular object keyword may be used in place of an unpopular field/object keyword.

At 610, the controller 320 sets keywords, appearing in the same documents as a popular field/object keyword, for a first attribute keyword candidate set.

The controller 320 may search for/collect documents containing a popular field/object keyword, and may set keywords, included in the collected documents, for a first attribute keyword candidate set. According to another embodiment, the controller 320 may exclude field keyword and object keywords among the keywords included in the collected documents from the first attribute keyword candidate set. Furthermore, the controller 320 may exclude a preset insignificant keyword, e.g., a postpositional particle/article, from the first attribute keyword candidate set. Furthermore, according to another embodiment, the controller 320 may include a keyword, registered in a preset dictionary, among the keywords included in the collected documents in a first attribute keyword candidate set.

Furthermore, according to another embodiment, the controller 320 may search for/collect documents containing a popular field/object keyword, and may include keywords, disposed within a preset distance from a popular field/object keyword or a sentence containing the keyword in the collected documents, in a first attribute keyword candidate set. Furthermore, according to another embodiment, the controller 320 may search for/collect documents containing a popular field/object keyword, and may include keywords, used to describe and modify the popular field/object keyword, in a first attribute keyword candidate set by analyzing the contexts of the collected documents.

The distance between keywords or the distance between a keyword and a sentence may be determined based on, e.g., any one or more of the number of sentences located between the two keywords or between the keyword and the sentence, the number of words located between the two keywords or between the keyword and the sentence, the number of phases located between the two keywords or between the keyword and the sentence, and the number of letters located between the two keywords or between the keyword and the sentence.

The controller 320 may first perform morpheme analysis in order to perform keyword analysis.

At 620, the controller 320 sets keywords, appearing in the same documents as an unpopular field/object keyword, for a second attribute keyword candidate set.

The controller 320 may search for/collect documents containing an unpopular field/object keyword, and may set keywords, included in the collected documents, for a second attribute keyword candidate set. According to another embodiment, the controller 320 may exclude a field keyword and an object keyword among keywords included in the collected documents from the second attribute keyword candidate set. Furthermore, the controller 320 may exclude a preset insignificant keyword, e.g., a postpositional particle/article and/or the like, from the second attribute keyword candidate set. Furthermore, according to another embodiment, the controller 320 may include a keyword, registered in a preset dictionary, among the keywords included in the collected documents in a second attribute keyword candidate set.

Furthermore, according to another embodiment, the controller 320 may search for/collect documents containing an unpopular field/object keyword, and may include keywords, disposed within a preset distance from an unpopular field/object keyword or a sentence containing the keyword in the collected documents, in a second attribute keyword candidate set. Furthermore, according to another embodiment, the controller 320 may search for/collect documents containing an unpopular field/object keyword, and may include keywords, used to describe and modify the unpopular field/object keyword, in a second attribute keyword candidate set by analyzing the contexts of the collected documents.

The distance between keywords or the distance between a keyword and a sentence may be determined based on, e.g., any one or more of the number of sentences located between the two keywords or between the keyword and the sentence, the number of words located between the two keywords or between the keyword and the sentence, the number of phases located between the two keywords or between the keyword and the sentence, and the number of letters located between the two keywords or between the keyword and the sentence.

The controller 320 may first perform morpheme analysis in order to perform keyword analysis.

At 630, the controller 320 may set keywords belonging to both the first attribute keyword candidate set and the second attribute keyword candidate set for a representative attribute keyword candidate set. In other words, keywords used to modify both a popular field/object keyword and an unpopular field/object keyword may be collected as the representative attribute keyword candidate set.

According to another embodiment, at 510, the controller 320 may include keywords each appearing along with an object keyword and/or a field keyword in the representative attribute keyword candidate set regardless of the popularity/unpopularity thereof.

Referring back to FIG. 5, at 520, the controller 320 extracts two or more subordinate keywords, correlated with each representative attribute keyword included in the representative attribute keyword candidate set, from the second set documents.

The second set documents used for the subordinate keyword extraction of 520 and the first set documents used for the representative attribute keyword candidate set extraction of 510 may be different document sets, or may be the same document set. For example, the first set documents may be a set including all collectable documents, and the second set documents may be a set including only documents in which a specific target field of interest for the providing of information providing service is used as a main keyword. The controller 320 may analyzes whether or not each document is a document in which a specific target field of interest for the providing of information providing service is used as a main keyword based on frequently appearing keywords by analyzing collectable documents. According to another embodiment, the first set documents and the second set documents may be all sets each including all collectable related documents. Furthermore, according to another embodiment, the first set documents may be a set including all collectable related documents, and the second set documents may be a set including only documents related to a specific target field of interest for the providing of information providing service. Furthermore, according to another embodiment, the second set documents may be a set including all collectable related documents, and the first set documents may be a set including only documents related to a specific target field of interest for the providing of information providing service.

For 520, the controller 320 may collect documents including a keyword representative of a specific target field of interest itself and/or documents each including an object keyword belonging to the corresponding field of interest, e.g., in order to generate a set including only documents related to the specific field of interest for the providing of information providing service, extracts documents in which the weight of a field keyword/object keyword is equal to or larger than a preset value, from among the collected documents, and may generate a set including only documents related to the specific field of interest. The weight of the field keyword/object keyword may be determined based on the appearing frequency or appearing locations of the field keyword/object keyword, context, or the like. For example, a document in which the field keyword/object keyword appears frequently, is used as the title of the corresponding document, or is described in large letters or emphasizing fonts may be classified as a document related to the specific field of interest.

At 520, the controller 320 may extract a preset number of subordinate keywords each having a high degree of correlation with each representative attribute keyword by, e.g., analyzing at least part of the second set documents, thereby extracting two or more subordinate keywords correlated with each representative attribute keyword.

The controller 320 may determine the degree of correlation between a representative attribute keyword and a subordinate keyword, e.g., by taking into account the frequency at which the subordinate keyword appears in the same or similar context as the representative attribute keyword. For example, words appearing near keyword A in a specific sentence may be viewed as also appearing near a word correlated with keyword A in another document.

‘I went on a trip after making a hard decision, but it was July and, thus, the weather was so hot that I suffered.’

‘I went on a trip after making a hard decision, but it was July and, thus, the weather was so humid that I suffered.’

Referring to the above two sentences, the word ‘hot’ is replaced with the word ‘humid’ in the same context. The controller 320 may infer that ‘hot’ and ‘humid’ are correlated words.

‘I went on a trip after making a hard decision, but it was July and, thus, the weather was so hot that I suffered.’

‘I went on vacation after making a hard decision, but it was July and, thus, the weather was so hot that I suffered.’

In the same manner, the controller 320 may infer from the above two sentences that ‘trip’ and ‘vacation’ are correlated words.

‘I went on a trip after making a hard decision, but it was July and, thus, the weather was so hot that I suffered.’

‘I went on a trip after making a hard decision, but it was August and, thus, the weather was so hot that I suffered.’

In the same manner, the controller 320 may infer that ‘July’ and ‘August’ are correlated words.

The controller 320 may stores information in which ‘hot’ and ‘humid’ are correlated words, ‘July’ and ‘August’ are correlated words, and ‘trip’ and ‘vacation’ are correlated words via previously collected documents. Thereafter, it is assumed that the following sentences are collected.

‘I went on vacation after making a hard decision, but it was July and, thus, the weather was so hot that I suffered.’

‘I went on a trip after making a hard decision, but it was August and, thus, the weather was so hot that I went through hardship.’

When the two sentences do not have the same context but it is known that ‘hot’ and ‘humid’ are correlated words, ‘July’ and ‘August’ are correlated words, and ‘trip’ and ‘vacation’ are correlated words, the controller 320 may learn that ‘suffer’ and ‘hardship’ are also correlated words via the above sentences.

It may be determined that a keyword pair having a high appearing frequency in the same/similar contexts has a high degree of correlation. Furthermore, it is determined that the higher the similarity between contexts in which two keywords appear is, the higher the degree of correlation between the two keywords is. The controller 320 may increase the accuracy of the determination of the degrees of correlation between keywords in such a manner as to set the degrees of correlation keywords by performing learning by using collected documents and then setting the degrees of correlation between keywords appearing in a corresponding sentence by using the set degrees of correlation between keywords and the context of the sentence.

As similar learning methods, Neural Net Language Model (NNLM), Recurrent Neural Net Language Model (RNNLM), word2vec, skipgram, and Continuous Bag-of-Words (CBOW) methods are known. In particular, when the word2vec method is used, the word2vec method may map individual keywords to vectors by performing learning by using documents, and may determine the similarity between two keywords through the cosine similarity calculation of two vectors.

By means of such a method or a similar method, the controller 320 may extract a preset number of subordinate keywords having the highest degree of correlation with each representative attribute keyword by analyzing at least part of the second set documents.

At 530, the controller 320 may extract a correlation weight corresponding to a pair of each representative attribute keyword within the representative attribute keyword candidate set and each subordinate keyword from the second set documents.

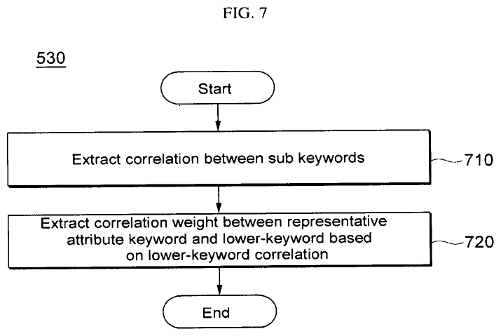

FIG. 7 is a detailed flowchart illustrating operation 530 according to an embodiment of the present disclosure.

At 710, the controller 320 may extract the degrees of correlation between the subordinate keywords by analyzing at least part of the second set documents. For example, it is assumed that subordinate keywords collected as subordinate keywords correlated with representative attribute keyword A1 are 50 subordinate keywords Bl₁ to B1₅₀. In such a case, the controller 320 may extract the degree of correlation between two subordinate keywords by using the frequency at which the two subordinate keywords appear in the same document, for these 50 subordinate keywords. The degree of correlation between B1₁ and B1₂ is determined based on the frequency at which B1₁ and B1₂ appear in the same document. According to another embodiment, the frequency at which B1₁ and B1₂ appear in the same document influences the degree of correlation, and, additionally, in the case where B1₁ and B1₂ appear in the same document, as the distance between the two keywords B1₁ and B1₂ (or the distance between the sentences in which two keyword appear) is closer, a higher degree of correlation may be recognized. In a similar method, the degrees of correlation between subordinate keywords may be extracted. The distance between keywords or the distance between a keyword and a sentence may be determined based on, e.g., any one or more of the number of sentences located between the two keywords or between the keyword and the sentence, the number of words located between the two keywords or between the keyword and the sentence, the number of phases located between the two keywords or between the keyword and the sentence, and the number of letters located between the two keywords or between the keyword and the sentence.

At 720, the controller 320 may extract correlation weights between each representative attribute keyword and the subordinate keywords based on the degrees of correlation between the subordinate keywords. For example, for a subordinate keyword set corresponding to each representative attribute keyword, the controller 320 may set a specific subordinate keyword within the subordinate keyword set and the representative attribute keyword so that the degree of correlation between the specific subordinate keyword within the subordinate keyword set and another subordinate keyword within the subordinate keyword set and a correlation weight between the specific subordinate keyword and the representative attribute keyword have a positive correlation therebetween.

For example, the higher the degrees of correlation between the subordinate keyword Bl₁ of the representative attribute keyword A1 and other subordinate keywords B1₂ to B1₅₀ of the representative attribute keyword A1 are, the higher value the correlation weight between A1 and B1₁ may be set to. For example, the arithmetic mean (or sum) of the degrees of correlation between Bl₁ and the other subordinate keywords B1₂ to B1₅₀ of A1 may become the correlation weight between B1₁ and A1. A geometric mean/harmonic mean may be used in place of a simple arithmetic mean. There may be used a truncated mean designed to calculate a mean with the two highest ones (examples) of the degrees of correlation between Bl₁ and the other subordinate keywords B1₂ to B1₅₀ of A1 and the two lowest ones (examples) thereof excluded from the calculation. A median may be used in place of the arithmetic mean of the degrees of correlation.

According to some embodiments, ‘the frequency at which B1₁ and B1₂ appear in the same document’ used to calculate the correlation weight of Bl₁ for A1 does not vary simply depending on the number of documents in which B1₁ and B1₂ appear together (in which B1₁ and B1₂ appear in the same sentence, or in which B1₁ and B1₂ appear in close proximity to each other), but may be obtained by dividing the number of documents in which B1₁ and B1₂ appear together (in which Bl₁ and B1₂ appear in the same sentence, or in which Bl₁ and B1₂ appear in close proximity to each other) by the number of documents in which B1₁ appears and/or the number of documents in which B1₂ appears. In a similar manner, ‘the frequency at which B1₁ and B1₂ appear in the same document’ may be set such that it has a positive correlation in connection with the number of documents in which B1₁ and B1₂ appear together (in which Bl₁ and B1₂ appear in the same sentence, or in which Bl₁ and B1₂ appear in close proximity to each other) and has a negative correlation in connection with the number of documents in which B1₁ appears and/or the number of documents in which B1₂ appears. This is a kind of normalization intended to prevent a frequently used word from simply having a high correlation weight in connection with the representative attribute keyword A1.

Referring back to FIG. 5, at 540, the controller 320 may extract the degrees of subordinate correlation between an object and subordinate keywords from the first set documents.

It may be determined that subordinate keywords frequently appearing in the same document, the same sentence or a close sentence as an object keyword (for example ‘Taylor Swift’) representative of an object in the first set documents are correlated with the corresponding object. The controller 320 may collect documents in which the object keyword of the corresponding object appears, and may extract the degree of subordinate correlation between each subordinate keyword and the object keyword based on the frequency at which they appear together within the documents. In particular, when a subordinate keyword appears in the same sentence as the object keyword, the controller 320 may set the degree of correlation between the subordinate keyword and the object to a higher value than when the subordinate keyword appears in a sentence different from that in which the object keyword appears.

The controller 320 may set the degree of correlation between the subordinate keyword and the object of the corresponding object keyword to a higher value in proportion to the proximity between a sentence in which the subordinate keyword appears and a sentence in which the object keyword appears. The proximity between two sentences may be determined based on, e.g., any one or more of the number of sentences located between the two sentences, the number of words located between the two sentences, the number of phases located between the two sentences, and the number of letters located between the two sentences.

The controller 320 may set the degree of correlation between the subordinate keyword and the object of the corresponding object keyword to a higher value in proportion to the proximity between a location at which the subordinate keyword appears and a location at which the object keyword appears. The proximity between the subordinate keyword and the object keyword may be determined based on, e.g., any one or more of the number of sentences located between the subordinate keyword and the object keyword, the number of words located between the subordinate keyword and the object keyword, the number of phases located between the subordinate keyword and the object keyword, and the number of letters located between the subordinate keyword and the object keyword.

At 550, the controller 320 may extract the degree of object-keyword correlation between the object and the representative attribute keyword by using the degrees of subordinate correlation of 540 and the correlation weights of 530.

For example, the degree of object-keyword correlation between object C and the representative attribute keyword A1 may be extracted using the degrees of subordinate correlation between C and the subordinate keywords (e.g., B1₁ to B1₅₀) of A1 and the correlation weights of the respectively subordinate keywords. For example, the degree of object-keyword correlation between the object C and the representative attribute keyword A1 may be set to a higher value in proportion to the degrees of subordinate correlation between the object C and the subordinate keywords Bl₁ to B1₅₀.

When the degree of subordinate correlation with the object C is higher for a subordinate keyword having a higher correlation weight in the relationship with A1, the degree of object-keyword correlation between the object C and the representative attribute keyword A1 may be set to a higher value for a subordinate keyword having a lower correlation weight than a case having a higher degree of subordinate correlation. For example, the degree of subordinate correlation of a keyword B1₁ having a higher correlation weight is higher in table 1 than in table 2, and thus the degree of object-keyword correlation between the object C and the representative attribute keyword A1 may be set to a higher value in table 1 than in table 2.

TABLE 1

| | Correlation weight in | Degree of subordinate |
|---|---|---|
| | connection with A1 | correlation with C |
| B1₁ | 0.5 | 0.5 |
| B1₂ | 0.2 | 0.2 |

TABLE 2

| | Correlation weight in | Degree of subordinate |
|---|---|---|
| | connection with A1 | correlation with C |
| B1₁ | 0.2 | 0.5 |
| B1₂ | 0.5 | 0.2 |

According to an embodiment, the degree of object-keyword correlation between the object C and the representative attribute keyword A1 may be obtained based on (or using) the sum of values obtained by multiplying correlation weights and the degrees of subordinate correlation corresponding to the individual subordinate keywords. In table 1, 0.5×0.5+0.2×0.2=0.29, and in table 2, 0.2×0.5+0.5×0.2=0.20. Accordingly, the degree of object-keyword correlation between the object C and the representative attribute keyword A1 may be set to a higher value in table 1 than in table 2. The above-described method of calculating the degree of object-keyword correlation is merely an example. As long as the degree of subordinate correlation in connection with C obtained at 540 and the correlation weight in connection with A1 obtained at 530 have a positive correlation with the degree of object-keyword correlation between C and A1, another method may be used.

Next, when the communication unit 310 receives a request for the providing of information correlated with the specific representative attribute keyword, the controller 320 may provide a result item via the communication unit 310 based on the degree of object-keyword correlation extracted at 550. For example, when receiving a request for the providing of information including any one representative attribute keyword, the controller 320 may provide information about objects in descending order of the degree of object-keyword correlation in the relationship with the corresponding representative attribute keyword.

In another embodiment, when receiving a request for the providing of information including two or more representative attribute keywords and corresponding weights, the controller 320 may provide information about objects in descending order of the sum (or mean) of values obtained by multiplying the degrees of object-keyword correlation with the representative attribute keywords included in the request for the providing of information by weights (or adding weights to the degrees of object-keyword correlation) for each object.

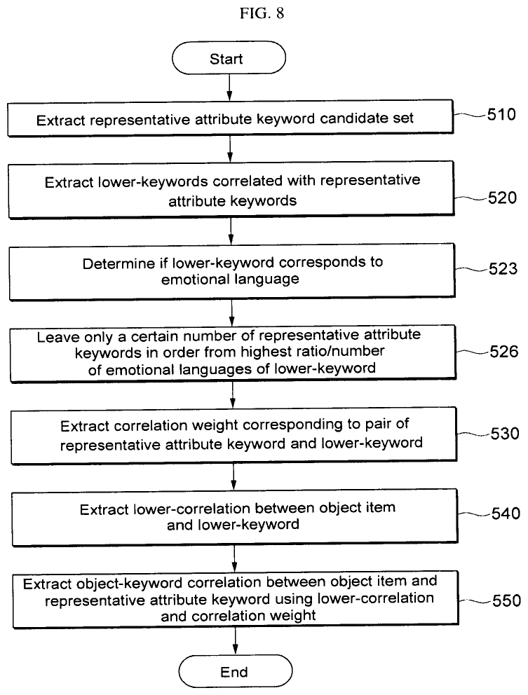

FIG. 8 is a flowchart illustrating a process of providing information according to another embodiment of the present disclosure.

The embodiment of FIG. 8 further includes two steps 523 and 526 between steps 520 and 530 in addition to processes identical to those of the embodiment of FIG. 5. In such a case, redundant descriptions will be omitted, and only steps 523 and 526 will be described.

At 523, the controller 320 determines whether each of the subordinate keywords extracted at 520 corresponds to an emotional word (emotional language). For this purpose, the storage 330 or external server may hold an emotional word dictionary. The emotional word dictionary is a tool for determining whether or not a word (keyword) is an emotional word, and may hold, e.g., an emotional word list. It may be determined that a keyword included in the emotional word list is an emotional word and a keyword not included in the emotional word list is not an emotional word. However, these determinations are based on dictionary meanings, and may not reflect the use of words by the public, which varies over time. Accordingly, the controller 320 determines whether to use a representative attribute keyword based on whether or not subordinate keywords correlated with the representative attribute keyword are emotional words without determining whether or not the representative attribute keyword itself is an emotional word.

In another embodiment, the controller 320 may add another word, having a high degree of correlation (equal to or larger than a preset value) with a preset or larger number of words registered in the emotional word dictionary as emotional words, to the emotional word dictionary.

At 526, the controller 320 may leave a preset number of representative attribute keywords in a representative attribute keyword candidate set in descending order of the emotional word percentage (or number) of correlated subordinate keywords, and may eliminate the remainder. Through this process, a keyword distant from an emotional word may be prevented from being treated as an emotional word.

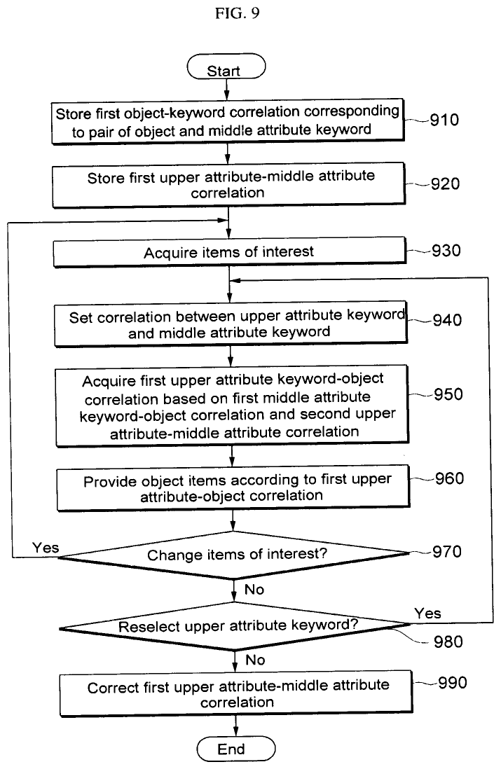

FIG. 9 is a flowchart illustrating a process of providing information according to an embodiment of the present disclosure.

At 910, the controller 320 stores a first middle attribute keyword-object correlation corresponding to pairs of middle attribute keywords and objects in the storage 330.

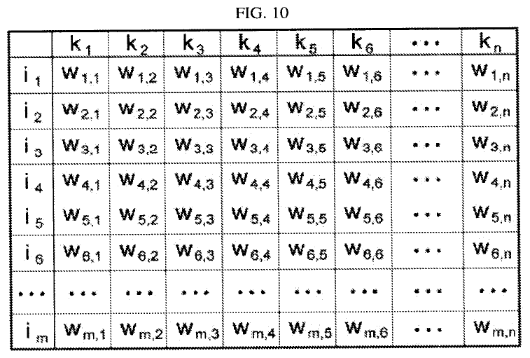

FIG. 10 shows an example of the stored first middle attribute keyword-object correlation according to an embodiment of the present disclosure.

In the embodiment of FIG. 10, there are m number i₁ to iₘ of objects, and n number k₁ to kₙ of middle attribute keywords.

For example, the first middle attribute keyword-object correlation between the object is and the middle attribute keyword keyword k₃ is w_{5,3}.

The process of 910 may be performed, e.g., according to part of the embodiments of FIGS. 5 to 8, a similar process, or an equivalent process. According to another embodiment, the process of 910 may be performed by the input of a manager, or by receiving the middle attribute keyword-object correlation, determined by an external system, via a network or storage medium.

Next, at 920, the controller 320 stores a first upper attribute-middle attribute correlation corresponding to pairs of upper attribute keywords and middle attribute keywords in the storage 330.

For example, the process of 920 may be performed by input of a manager, or by receiving the degree of basic reserved word-keyword correlation, determined by an external system, via a network or storage medium. According to another embodiment, the process of 920 may be performed by analyzing collectable documents, such as Internet information, SNS information, news, etc., and using a method similar to the processes of FIGS. 5 to 8. Furthermore, the process of 920 may include a process of reflecting the feedback of a user, as will be described below.

At 930, the communication unit 310 receives and acquires an item of interest from the terminal 200, and transfers the received item of interest to the controller 320.

The received item of interest is an item of interest received by the terminal 200 from a search user.

At 940, the controller 320 sets a correlation relationship between the upper attribute keyword and the middle attribute keyword according to the manager input.

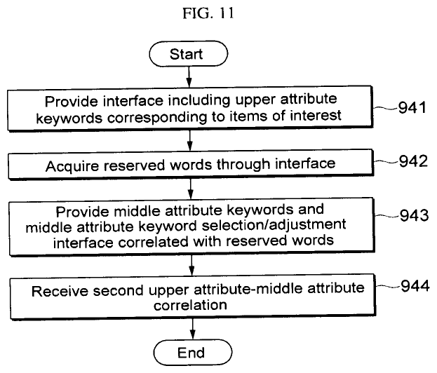

FIG. 11 is a detailed flowchart illustrating operation 940 according to an embodiment of the present disclosure.

Referring to FIG. 11, at 941, the controller 320 extracts a plurality of upper attribute keywords for the item of interest, and provides an interface including the upper attribute keywords to the terminal.

At 942, the controller 320 receives, as a reserved word, one or more upper attribute keywords that have been selected by the terminal through the interface.

In such an embodiment, the reserved word is an upper attribute keyword received from a search user (manager or customer) among the plurality of upper attribute keywords included in an attribute set.

At 943, the controller 320 extracts a middle attribute keyword correlated with the reserved word by using the pre-stored first upper attribute-middle attribute correlation and provides, as a second attribute filter, to the terminal 200, a middle attribute keyword selection/adjustment interface, including the middle attribute keyword correlated with the reserved word and middle attribute keywords similar to the middle attribute keyword. Through this interface, the user may additionally select the middle attribute keyword to be set as correlated with the reserved word or remove/delete the middle attribute keyword that is set as correlated with the reserved word to be unrelated.

At 944, the controller 320 receives an input of a second upper attribute-middle attribute correlation for each of one or more middle attribute keywords selected as correlated with the reserved word from the terminal through the interface.

For example, when any one middle attribute keyword is selected according to a user's input from among the plurality of middle attribute keywords included in the interface, the second upper attribute-middle attribute correlation may be input by automatically moving the selected middle attribute keyword to the front of an array of the plurality of middle attribute keywords. The controller 320 may, for example, assign the second upper attribute-middle attribute correlation according to an arrangement order of the middle attribute keywords. That is, it may be corrected so that as the arrangement order is faster, the second upper attribute-middle attribute correlation becomes higher.

In another modified embodiment the second upper attribute-middle attribute correlation may be input by rearranging the order of the plurality of second attribute keywords included in the interface. The controller 320 may, for example, assign the second upper attribute-middle attribute correlation according to the rearranged order. That is, it may be corrected so that as the arrangement order is faster, the second upper attribute-middle attribute correlation becomes higher.

In another modified embodiment, the second upper attribute-middle attribute correlation may be directly input through the interface.

The first upper attribute-middle attribute correlation is corrected by reflecting the second upper attribute-middle attribute correlation to the pre-stored first upper attribute-middle attribute correlation. The correction on the first upper attribute-middle attribute correlation will be described in detail with reference to 990 described below.

Referring back to FIG. 9, at 950, the controller 320 calculates a first upper attribute keyword-object correlation corresponding to a pair of the selected upper attribute keyword and an object based on a first middle attribute keyword-object correlation.

At 960, the controller 320 may provide an object item according to the first upper attribute keyword-object correlation corresponding to the received reserved word, the selected upper attribute keyword.

In other words, the controller 320 may provide object items in descending order of the first upper attribute keyword-object correlation corresponding to the received reserved word. The terminal 200 having received the object items may provide information about the object i₃ to the user through the display 220. The terminal 200 may provide information about another object at a lower order position, when necessary. The terminal 200 may provide information about the object i₃ to the user by voice through a speaker in place of the display 220.

If a change of item of interest is input through the interface at 970, the process may return to 930, and if a change of item of interest is not input, the process proceeds to 980.

If the selection change of the upper attribute keyword (reserved word) is input through the interface at 980, the process may return to 940, and if the upper attribute keyword (reserved word) change is not input, the process proceeds to 980.

At 990, the first upper attribute-middle attribute correlation is corrected by reflecting the second upper attribute-middle attribute correlation selected at 950.

The first upper attribute-middle attribute correlation may be reset according to the received second upper attribute-middle attribute correlation.

By repetition of this process, the second upper attribute-middle attribute correlation selected by the user is reflected in the database.

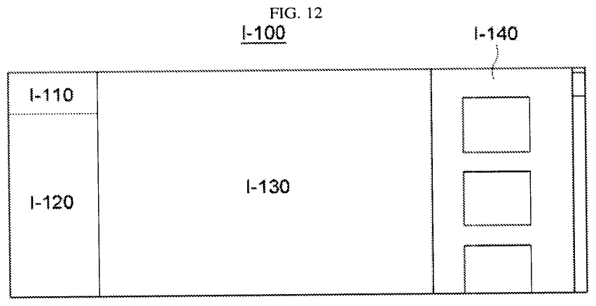

FIGS. 12 to 18 illustrate examples of an interface page including an attribute filter according to an embodiment of the present disclosure.

As used herein, the attribute filter may be referred to as an attribute filter in the sense that it acts as a filter representing a user's desired attribute.

Referring to FIG. 12, an interface page I-100 including the attribute filter may include an item of interest display I-110, a first attribute filter I-120, a second attribute filter I-130, and a result previewer I-140.

An item of interest display I-110 may be further included.

The item of interest display I-110 displays an item of interest selected by the user.

The user may change the item of interest through the item of interest display I-110.

For example, when the user selects the item of interest display I-110, an interface for selecting items of interest is provided, so that the user may change the item of interest by inputting an item of interest or selecting from a list of a plurality of items of interest.

In the first attribute filter I-120, an upper attribute keyword for the item of interest selected by the user is provided as a first attribute filter.

The attribute filter displayed on the first attribute filter I-120 may include reserved words that are calculated by a reservation word-object correlation.

The user may select one or more upper attribute keywords from among the plurality of upper attribute keywords provided in the first attribute filter.

For example, when the information providing apparatus 300 receives ‘broadcast’ as the item of interest selected by the user, the information providing apparatus 300 may provide pre-stored ‘good,’ ‘various,’ ‘prepared,’ ‘best,’ ‘interesting’ and the like as the first attribute filter, and may receive an upper attribute keyword among keywords included in the first attribute filter from the user through the terminal 200.

The selected upper attribute keyword is displayed distinguishably from other upper attribute keywords that are not selected.

In an embodiment, the first attribute filter I-120 may further include the item of interest display I-110.

The item of interest display I-110 displays the item of interest selected by the user.

The user may change the item of interest through the item of interest display I-110.

For example, when the user selects the item of interest display I-110, an interface for selecting an item of interest is provided, so that the user may change the item of interest by inputting an item of interest or selecting from a list of the plurality of items of interest.

It is obvious that when the item of interest is changed, the first attribute filter is also changed.

For example, if the item of interest is ‘movie,’ the first attribute filter may include ‘cinematic quality,’ ‘visual quality,’ ‘striking,’ ‘philosophical,’ ‘emotional,’ ‘good OST,’ ‘masterpiece,’ ‘good sound,’ ‘good view,’ ‘probable,’ ‘spectacle,’ ‘scenery,’ ‘calm,’ ‘fine work,’ ‘sweet,’ ‘characterful,’ ‘good story,’ ‘best,’ ‘life,’ ‘recommended,’ and the like.

If the item of interest is ‘travel,’ the first attribute filter may include ‘classic,’ ‘food travel,’ ‘romantic,’ ‘starry,’ ‘beautiful sunset,’ ‘healing,’ ‘beautiful colors,’ ‘blue sky,’ ‘better than expected,’ ‘good for family,’ ‘good for tea,’ ‘clean,’ ‘satisfactory,’ ‘exciting,’ ‘thrilling,’ ‘mysterious’, ‘impressive,’ ‘good for free travel,’ ‘stunning,’ ‘pleasant’ and the like.

The second attribute filter I-130 displays an attribute set of middle attribute keywords as a second attribute filter.

The second attribute filter includes a plurality of middle attribute keywords (attribute set) selected based on a predetermined correlation with the upper attribute keyword selected by the user through the first attribute filter I-120. Accordingly, when the upper attribute keyword is changed through the first attribute filter I-120, the attribute set included in the second attribute filter I-130 is also changed.

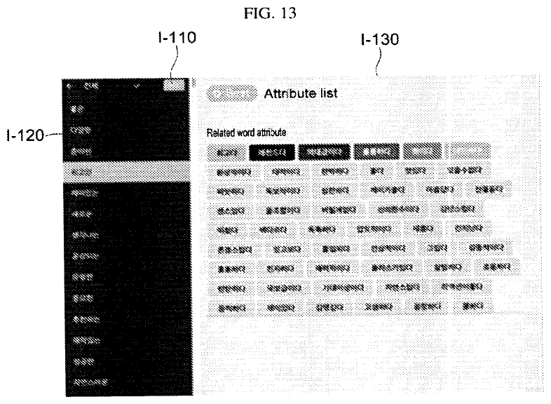

FIG. 13 illustrates an example of the first attribute filter I-120 and the second attribute filter I-130 included in the interface page of FIG. 12.

For the upper attribute keyword selected in the first attribute filter, the controller 320 generates an attribute set including a plurality of middle attribute keywords based on a preset upper attribute-middle attribute correlation, and provides an interface including the generated attribute set. Through the second attribute filter I-130, a similarity corresponding to the upper attribute keyword-middle attribute keyword pair for the middle attribute keyword may be input from the user.

The second attribute filter I-130 of FIG. 13 is an example of the interface.

In the interface, a plurality of middle attribute keywords correlated with the upper attribute keyword are arranged.

FIG. 13 illustrates an example of the second attribute filter when ‘best’ is selected as the upper attribute keyword through the first attribute filter, in which a representative middle attribute keyword ‘best’ stored in association with the selected upper attribute language ‘best’ is firstly displayed, and ‘legendary,’ ‘legend,’ ‘great,’ ‘amazing,’ ‘cool,’ ‘fantastic,’ ‘awesome’ ‘perfect,’ ‘good,’ ‘fascinating,’ ‘unforgettable,’ ‘extraordinary,’ ‘thrilled,’ ‘crazy, ‘crazy,’ ‘strong,’ ‘good sense,’ ‘beautiful,’ charming,’ etc. that are similar to the representative middle attribute keyword ‘best’ are arranged in order. The similarity between ‘best’ and other keywords may be determined based on, for example, the frequency that two keywords appear simultaneously in the same document, the frequency that the two keywords appear simultaneously within a certain distance within the same sentence, and the like. For example, a relative distance between the two keywords is determined by using a word-to-vector (W2V; Word2vec) related to the item of interest or a similar technique, and the two keywords are considered to be more similar as the relative distance between the two words is closer.

The representative middle attribute keyword may be displayed differently from other middle attribute keywords. For example, the representative middle attribute keyword ‘best’ may be displayed in yellow, and other middle attribute keywords may be displayed in black. For the middle attribute keywords other than the representative middle attribute keyword, any one or more of brightness/saturation/color of the background or text color of the representative middle attribute keyword may be displayed differently.

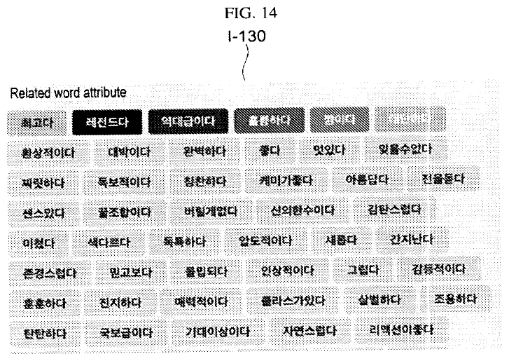

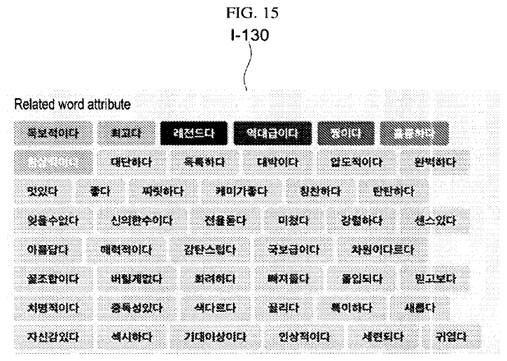

FIGS. 14 and 15 illustrate examples of an interface page including the second attribute filter according to an embodiment of the present disclosure.

As illustrated in FIG. 14, as farther away from the representative middle attribute keyword (more dissimilar), the background may be gradually displayed palely. For example, according to a range in which the similarity between the representative middle attribute keyword(s) and each of middle attribute keywords not belonging to the representative middle attribute keyword falls, font color, background color, font, font thickness, and frame around font of each middle attribute keyword may be displayed differently to be distinguished. In addition, it may be applied that the middle attribute keywords more similar to the representative middle attribute keywords in the front (upward).

An arrangement order of the attribute set displayed on the second attribute filter I-130 may be changed by the user.

For example, when an arbitrary middle attribute language is selected from among the arranged middle attribute keywords, the terminal 200 may transmit an input information, converted from the user's input, to the information providing apparatus 300.

The information providing apparatus 300 rearranges the order of the middle attribute keywords of the second attribute filter according to the input information received from the terminal 200.

For example, the middle attribute keyword selected by the user is preferentially placed. Being placed preferentially means that the selected middle attribute keyword is displayed to be more recognizable for the user than unselected middle attribute keywords. For example, it is placed first in an array of middle attribute keywords. As illustrated in FIG. 15, when ‘unique’ (P) is selected by the user from the second attribute filter portion illustrated in the second attribute filter I-130, ‘unique’ (P) is placed before ‘best’ in the second attribute filter I-130 illustrated in FIG. 15. In addition, with respect to the middle attribute keywords selected as being correlated with the upper attribute keyword, a certain number of keywords having a high degree of similarity to the selected middle attribute keywords may be preferentially displayed after the selected middle attribute keyword, and/or may be displayed in a distinct color.

According to another example, when the terminal 200 receives an input of changing an arrangement position of the middle attribute keywords arranged in the second attribute filter I-130 by the user, the terminal 200 transmits the related input information to the information providing apparatus 300, and the controller 320 of the information providing apparatus 300 rearranges the middle attribute keywords of the second attribute filter I-130 according to the input information received from the terminal 200.

When the information providing apparatus 300 receives and stores user information from the terminal, the information providing apparatus 300 stores the rearranged second attribute filter in association with the user information, and later, the rearranged second attribute filter may be provided for the same ‘reserved word’ when it is selected by the same user.

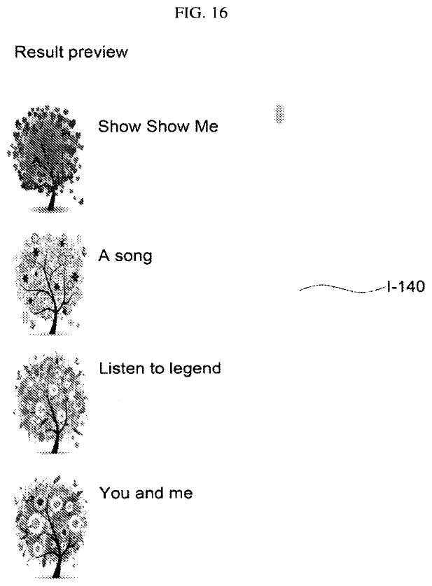

FIG. 16 illustrates an example of an interface page including a result previewer according to an embodiment of the present disclosure.

As illustrated in FIG. 16, the result previewer I-140 provides information on one or more objects searched based on the selected attribute language. That is, object information searched according to the user's selection through the first attribute filter I-120 and the second attribute filter I-130 is provided through the result previewer I-140.

The result previewer I-140 may display an image and an individual item name (e.g., a broadcast program/book) for the searched object based on the selected attribute language. When there are multiple searched objects, the objects may be displayed in the order of high correlation.

When the searched object is, for example, a broadcast program, a main image, title, etc. of the broadcast program may be displayed.

When an arbitrary object is selected from a plurality of objects, detailed information on the corresponding object may be provided.

In a case where the searched object is, for example, a broadcast program, when an arbitrary broadcast program is selected, the schedule of the broadcast program, the highest viewing rate, genre, performer, production team, official homepage address, etc. may be displayed in detail.

Through the result preview, the user may check in advance the objects to be searched according to the virtual situation. Accordingly, when an object that is not suitable for the virtual situation is searched, the setting for the virtual situation may be changed so that objects are re-searched, thereby providing a result suitable for the virtual situation that the user desires.

In addition, when an object displayed in the result preview is determined as a final result, the attribute language and weight selected for recommending the corresponding object as the result may be stored.

In such an embodiment, in the case of a user who has undergone a user authentication procedure, the information providing apparatus may store attribute language and weight search information together with user log information, and later when the same user searches for the corresponding attribute language, the information providing apparatus may display the stored attribute language and weight information.

For example, it is assumed that an authenticated user selects ‘best’ through the first attribute filter I-120 and places ‘unique’ in the front through the second attribute filter I-130, and then a search result where a weight of ‘unique’ is set to 1 through the weight adjuster I-130 is stored. In a case where the same user selects ‘best’ through the first attribute filter I-120, the second attribute filter I-130 with ‘unique’ placed in the front and the weight adjuster I-135 having a weight set to 1 for ‘unique’ may be provided.

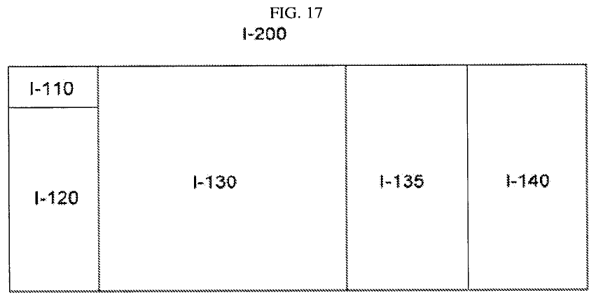

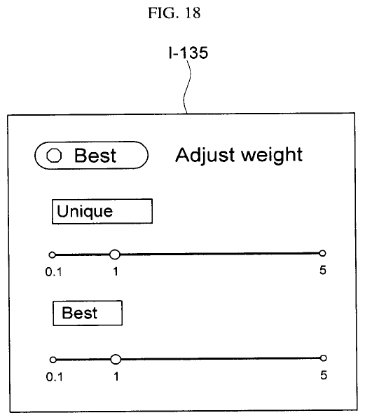

FIG. 17 illustrates an example of an interface page including an attribute filter according to another embodiment of the present disclosure, and FIG. 18 illustrates an example of an interface page including a weight adjuster I-135 according to an embodiment of the present disclosure.

An interface page I-200 may include an item display I-110, a first attribute filter I-120, a second attribute filter I-130, a weight adjuster I-135, and a result previewer I-140.

In FIG. 17, the same reference numerals as in FIG. 12 represent the same components, and thus repeated description will be omitted and only the weight adjuster I-135 which is different from that of FIG. 12 will be described.

The weight adjuster I-130 provides a weight adjustment interface that is adjustable by the user for each of middle attribute keywords displayed in the second attribute filter I-130. Accordingly, the user selects the weight of the attribute language.

The weight may be selected from 0.1 to 5, for example. This number is only an example and embodiments of the present disclosure are not limited thereto.

The selected weight affects an upper attribute-middle attribute correlation corresponding to the pair of the upper attribute keywords and the middle attribute keywords. The correlation affects the result preview and actual results.

According to a method of managing attribute language by an information providing apparatus in an embodiment of the present disclosure, it is possible to recommend an object suitable for a virtual situation considered by the user.

In such a case, it may be understood that individual blocks of the flowcharts and/or combinations of the blocks of the flowcharts may be performed by computer program instructions. Since it is possible to install these computer program instructions on a general-purpose computer, a special computer, or the processor of a programmable data processing apparatus, the instructions executed through the computer or the processor of the programmable data processing apparatus generate a means for performing functions which are described in the blocks of the flowcharts. Furthermore, since it is possible to store these computer program instructions in computer-usable or computer-readable memory that may be oriented to a computer or some other programmable data processing apparatus in order to implement functions in a specific manner, it is possible to manufacture products in which instructions stored in computer-usable or computer-readable memory include means for performing functions described in the blocks of flowcharts. Moreover, since it is possible to install computer program instructions on a computer or another programmable data processing apparatus, instructions for performing a series of operational steps on the computer or the programmable data processing apparatus, generating processes executed by the computer and operating the computer or the programmable data processing apparatus may provide steps for performing functions described in the blocks of flowcharts.

Furthermore, each block may refer to part of a module, a segment, or code including one or more executable instructions for performing one or more specific logical functions. Moreover, it should be noted that in some alternative embodiments, functions described in blocks may occur out of order. For example, two successive blocks may be actually performed at the same time, or sometimes may be performed in reverse order according to relevant functions.

In such a case, the term ‘unit’ used herein refers to a software or hardware component, such as an FPGA or ASIC, which performs a function. However, the term ‘unit’ is not limited to a software or hardware component. The unit may be configured to be stored in an addressable storage medium, or may be configure to run one or more processors. For example, the unit may include components, such as software components, object-oriented software components, class components and task components, processes, functions, attributes, procedures, subroutines, segments of program codes, drivers, firmware, microcode, circuits, data, databases, data structures, tables, arrays, and variables. Functions provided by components and units may be combined into a smaller number of components and units, or may be divided into a larger number of components and units. Furthermore, components and units may be each implemented to run one or more CPUs within an apparatus or security multimedia card.

As set forth hereinabove, one or more embodiments of the present disclosure may provide a method and an apparatus for managing attribute languages.

It will be understood by those having ordinary knowledge in the art to which the present disclosure pertains that the present disclosure may be practiced in other specific forms without changing the technical spirit or essential feature of the present disclosure. Therefore, the above-described embodiments should be understood as being illustrative, not limitative, in all aspects. The scope of the present disclosure is defined based on the attached claims rather than the detailed description, and the claims, equivalents to the claims, and all modifications and alterations derived from the claims and the equivalents should be construed as being included in the scope of the present disclosure.

Meanwhile, although the embodiments of the present disclosure have been disclosed in the present disclosure and the accompanying drawings and the specific terms have been used, this is intended merely to easily describe the technical spirit of the present disclosure and help to understand the present disclosure, but is not intended to limit the scope of the present disclosure. It will be apparent to those having ordinary knowledge in the art to which the present disclosure pertains that other modified embodiments based on the technical spirit of the present disclosure may be implemented in addition to the disclosed embodiments.

What is claimed is:

1. A method of managing attribute language by an information providing apparatus, the method comprising:
when an upper attribute keyword is selected, based on a first upper attribute-middle attribute correlation corresponding to pairs of upper attribute keywords-middle attribute keywords, generating a middle attribute set including middle attribute keywords having the first upper attribute-middle attribute correlation higher than or equal to a reference value;
providing an interface for adding or deleting a middle attribute keyword to or from the middle attribute set, along with the upper attribute keyword, and adding or deleting, according to a user's input, a middle attribute keyword to or from the middle attribute set;
calculating a first upper attribute keyword-object correlation corresponding to a pair of the selected upper attribute keyword and an object selected based on a first middle attribute keyword-object correlation; and
providing the object corresponding to the first upper attribute keyword-object correlation to the interface.

2. The method of managing attribute language of claim 1, further comprising:
providing an interface including an attribute set, and receiving an input of a second upper attribute-middle attribute correlation for each middle attribute keyword selected through the interface; and
correcting the first upper attribute-middle attribute correlation by reflecting the second upper attribute-middle attribute correlation.

3. The method of managing attribute language of claim 1, further comprising:
indicating the middle attribute keywords of the middle attribute set to be distinguished from other middle attribute keywords; and
indicating middle attribute keywords other than the middle attribute set to be distinguished from one another according to a range to which average similarities with the middle attribute keywords of the middle attribute set belong.

4. The method of managing attribute language of claim 2, wherein receiving the input of the second upper attribute-middle attribute correlation includes:
receiving an input of a change in arrangement order of the middle attribute keywords included in the middle attribute set through the interface; and
changing the second upper attribute-middle attribute correlation with a predetermined correlation corresponding to the arrangement order.

5. The method of managing attribute language of claim 1, further comprising: before generating the middle attribute set,
generating an upper attribute filter including a plurality of preset upper attribute keywords; and
providing an interface including the upper attribute filter and receiving a selection of an arbitrary upper attribute keyword through the interface.

6. The method of managing attribute language of claim 5, further comprising: before generating the upper attribute filter,
providing an interface including a plurality of preset items of interest, and receiving a selection of an arbitrary item of interest through the interface; and
resetting, as the upper attribute keyword, the upper attribute keyword correlated with the item of interest.

7. The method of managing attribute language of claim 1, further comprising: before generating the middle attribute set,
storing the first middle attribute keyword-object correlation based on a first middle attribute-lower attribute correlation corresponding to pairs of middle attribute keywords and lower attribute keywords and a first lower attribute-object correlation corresponding to pairs of lower attribute keywords and objects.

8. The method of managing attribute language of claim 7, calculating the first upper attribute keyword-object correlation corresponding to the pairs of the upper attribute keywords and the objects includes calculating the first upper attribute keyword-object correlation corresponding to the pairs of the upper attribute keywords and the objects by multiplying the first upper attribute-middle attribute correlation by the first middle attribute keyword-object correlation.

9. An information providing apparatus, comprising:
a storage configured to store a first upper attribute-middle attribute correlation corresponding to pairs of upper attribute keywords and middle attribute keywords and a first middle attribute keyword-object correlation corresponding to pairs of middle attribute keywords and objects;
a controller configured to generate a middle attribute set including middle attribute keywords having the first upper attribute-middle attribute correlation higher than or equal to a reference value based on the first upper attribute-middle attribute correlation and to provide an interface for adding or deleting a middle attribute keyword to or from the middle attribute set, along with the upper attribute keyword; and
a communication unit configured to receive addition/delete of the middle attribute keyword to or from the middle attribute set by a user's input through the interface,
wherein the controller calculates a first upper attribute keyword-object correlation corresponding to a pair of the selected upper attribute keyword and an object selected based on a first middle attribute keyword-object correlation and provides the object corresponding to the first upper attribute keyword-object correlation to the interface.

10. The information providing apparatus of claim 9, wherein the controller provides an interface including an attribute set, receives an input of a second upper attribute-middle attribute correlation for each middle attribute keyword selected through the interface and corrects the first upper attribute-middle attribute correlation by reflecting the second upper attribute-middle attribute correlation.

11. The information providing apparatus of claim 10, wherein the interface indicates the middle attribute keywords of the middle attribute set to be distinguished from other middle attribute keywords, and indicates middle attribute keywords other than the middle attribute set to be distinguished from one another according to a range to which average similarities with the middle attribute keywords of the middle attribute set belong.

12. The information providing apparatus of claim 10, wherein the communication unit receives an input of a change in arrangement order of the middle attribute keywords included in the middle attribute set through the interface, and
the controller changes the second upper attribute-middle attribute correlation with a predetermined correlation corresponding to the arrangement order.

13. The information providing apparatus of claim 9, wherein the controller generates an upper attribute filter including a plurality of preset upper attribute keywords and provides an interface including the upper attribute filter, and
the communication unit receives an input of an arbitrary upper attribute keyword through the interface.

14. The information providing apparatus of claim 13, wherein the controller provides an interface including a plurality of preset items of interest, and resets, as the upper attribute keyword, the upper attribute keyword correlated with the item of interest input through the interface.

15. The information providing apparatus of claim 9, wherein the controller calculates the first middle attribute keyword-object correlation based on a first middle attribute-lower attribute correlation corresponding to pairs of middle attribute keywords and lower attribute keywords and a first lower attribute-object correlation corresponding to pairs of lower attribute keywords and objects.

16. The information providing apparatus of claim 15, wherein the controller calculates the first upper attribute keyword-object correlation corresponding to the pairs of the upper attribute keywords and the objects by multiplying the first upper attribute-middle attribute correlation by the first middle attribute keyword-object correlation.
